(19) United States
(12) Patent Application Publication
(10) Pub. No.: US 2026/0299618 A1
(43) Pub. Date: Oct. 1, 2026

(54) ROBOT

(71) Applicant: HONDA MOTOR CO., LTD., Tokyo (JP)

(72) Inventor: Jun Ashihara, Tokyo (JP)

(21) Appl. No.: 19/549,024

(22) Filed: Feb. 25, 2026

(30) Foreign Application Priority Data
Mar. 31, 2025 (JP) 2025-058105

(51) Int. Cl. G05D 1/689; B25J 9/10; B25J 19/00; B63G 8/00; G05D 1/49; G05D 107/00; G05D 109/30

(52) U.S. Cl. CPC G05D 1/6895; B25J 9/102; B25J 9/104; B25J 19/002; B63G 8/001; G05D 1/498; B63G 2008/004; B63G 2008/005; G05D 2107/25; G05D 2109/38

(57) ABSTRACT

The robot that does work underwater includes a robot main body, a propulsor, an arm unit 4, and a controller. The arm unit 4 includes at least one link 7 (a first link 11 and a second link 12), and a work part 8 provided at a tip end portion of the link 7. The link 7 includes: a link body 81; a coupling part 82, which couples the link body 81 to be rotatable about a rotation axis OX; and an actuator 83, which rotates the link body 81. The coupling part 82 is provided at a position equivalent to a gravity center position G1 or G2 of each link body 81 in the longitudinal direction of the link 7.

### CROSS-REFERENCE TO RELATED APPLICATION

Priority is claimed on Japanese Patent Application No. 2025-058105, filed Mar. 31, 2025, the content of which is incorporated herein by reference.

### BACKGROUND OF THE INVENTION

### FIELD OF THE INVENTION

The present invention relates to a robot.

### DESCRIPTION OF RELATED ART

For underwater robots that do work underwater, various techniques for conducting posture control of the robots have been conventionally proposed.

For example, Patent Literature 1 (Japanese Patent Publication No. 6167317) discloses a constitution of an underwater robot including a frame, a propulsor, a weight, a buoyancy material, and a drive mechanism. The weight moves along a first axis direction (a front-rear direction), and the buoyancy material is movable along a second axis direction (an up-down direction) orthogonal to the first axis.

According to the technique described in Patent Literature 1, the weight and the buoyancy material are moved in synchronization with each other, so that the position and posture of the robot can be controlled in any state.

### SUMMARY OF THE INVENTION

In such an underwater robot, a work part (a mechanical arm and the like) is provided to do work underwater, in some cases. For example, in a case where an extensible work arm is provided, as the work arm is spread away from the robot main body, the gravity center of the entire robot moves toward the work arm, and the posture of the robot changes. Hence, in order to maintain the posture of the robot, it is necessary to conduct posture control from the robot main body in accordance with extension and bending of the work arm.

However, in the prior art of conducting the posture control every time the work arm is extended or bent, it is necessary to always conduct the posture control, which may lead to an increase in the energy consumption.

Therefore, it is an object of the present invention to provide a robot capable of suppressing energy consumption to be smaller than that in the prior art.

In order to solve the above-described problem, the present invention adopts the following aspects.
(1) A robot according to an aspect of the present invention includes: a robot main body; a propulsor configured to drive the robot main body; an arm unit coupled with the robot main body and including at least one link and a work part provided at a tip end portion of the at least one link; and a controller configured to control an actuator and the propulsor, the actuator being configured to drive the arm unit, wherein the at least one link includes: a link body; a coupling part that couples the link body with the robot main body for the link body to be rotatable about a rotation axis; and the actuator that is attached to the link body, and that rotates the link body about the rotation axis, and wherein the coupling part is provided at a position equivalent to a gravity center position of the at least one link in a longitudinal direction of the at least one link, the at least one link including the link body, the actuator and an attached component attached to a tip end portion of the link body.
(2) In the robot described in the above (1), the at least one link may include a first link and a second link, the first link may include: a first link body; a first coupling part that couples the robot main body with the first link body to be rotatable about a first rotation axis; and a first actuator that rotates the first link about the first rotation axis, the second link may include: a second link body connected with a tip end portion of the first link body; a second coupling part that couples the tip end portion of the first link body with the second link body to be rotatable about a second rotation axis; and a second actuator that rotates the second link about the second rotation axis, the work part may be provided at a tip end portion of the second link body, the first coupling part may be provided at a position equivalent to a gravity center position of the first link in a longitudinal direction of the first link, the first link including the first link body, the first actuator and a first attached component attached to the tip end portion of the first link body, and the second coupling part may be provided at a position equivalent to a gravity center position of the second link in a longitudinal direction of the second link, the second link including the second link body, the second actuator and the work part attached to the tip end portion of the second link body.
(3) In the robot described in the above (1), the actuator may be provided to be closer to a base end portion than to the coupling part in the longitudinal direction of the at least one link, the base end portion being positioned at an opposite end to the tip end portion to which the attached component is attached.
(4) In the robot described in the above (1), the at least one link may further include a buoyancy body provided to be closer to the tip end portion of the at least one link than to the coupling part in the longitudinal direction of the at least one link, and the robot may do work underwater.
(5) In the robot described in the above (1), the at least one link may further include a counterweight provided to be closer to a base end portion than to the coupling part in the longitudinal direction of the at least one link, the base end portion being positioned at an opposite end to the tip end portion to which the attached component is attached.
(6) The robot described in the above (1) may further include a transmission mechanism including: a first gear connected with an output shaft of the actuator; and a second gear connected with the first gear to transmit rotational force from the first gear to the coupling part.
(7) In the robot described in the above (6), at least one of the first gear or the second gear may be a bevel gear.
(8) The robot described in the above (1) may further include a transmission mechanism including: a driving pulley connected with an output shaft of the actuator; a driven pulley connected with the coupling part; and a belt that transmits output from the driving pulley to the driven pulley. (9) In the robot described in one of the above (1) to (8), the controller may include a posture controller configured to conduct posture control to change at least one of a gravity center or a buoyancy center of the robot by moving a buoyancy member, the work part may serve as a hand including a plurality of fingers, and the controller may determine whether the hand is grasping an object, and may switch between validity and invalidity of the posture control based on a determination result.

According to the above aspect (1), the arm unit includes the link body, the coupling part, and the actuator. The link body rotates about the coupling part, and thus it becomes possible to extend or bend the arm unit (or the work part provided at the tip end portion of the arm unit) with respect to the robot main body. In addition, the coupling part is provided at a position equivalent to the gravity center position of the link in the longitudinal direction of the link. Thus, even when the arm unit is extended or bent in accordance with the rotation of the link body, a change amount of the gravity center position in the entire arm unit can be made small. In particular, in a case where the position of the coupling part coincides with the gravity center position of the link, the gravity center position in the entire arm unit is unchanged regardless of extension or bending of the arm unit. Therefore, the energy consumption related to the posture control can be suppressed to be smaller than that in the prior art in which the posture control is conducted every time whenever the arm unit is extended or bent. In addition, even in a case where the disposed position of the coupling part is provided in the vicinity of the gravity center position of the link (that is, a case where the position of the coupling part does not completely coincide with the gravity center position of the link), the energy consumption can be smaller than that in the prior art. Here, in general, in a case where the arm unit is constituted using the link mechanism, in order to maximize the movable range of the arm unit, the coupling part (the rotation axis of the link) is provided near the end portion of the link, in many cases. That is, in the prior art in which no consideration is given to the gravity center position, the coupling part is provided at a position away from the gravity center position of the link, in many cases. On the other hand, according to an aspect of the present invention, by providing the coupling part in the vicinity of the gravity center position of the link, it becomes possible to make a change in posture in accordance with extension or bending of the arm unit smaller than that in the prior art in which the coupling part is provided at a position away from the gravity center position of the link. Therefore, the energy consumption amount related to the posture control can be made smaller.

Therefore, it becomes possible to provide a robot capable of suppressing the energy consumption to be smaller than that in the prior art.

According to the above aspect (2), since the arm unit includes two links, which are the first link and the second link, each link is made to rotate about its rotation axis, so that a large movable range in accordance with extension or bending of the arm unit can be ensured. In addition, since the coupling part of each link is provided at a position equivalent to each of the gravity center positions in each link, even in a case where a plurality of links are used, a change amount of the gravity center position in the entire arm unit in accordance with extension or bending of the arm unit can be suppressed to be small. Therefore, it becomes possible to improve the convenience of the robot, while suppressing energy consumption.

According to the above aspect (3), since the actuator, which is a heavy object, is provided to be closer to the base end portion of the link body, it becomes easy to balance the weight with the attached component, which is provided to be closer to the tip end portion of the link. In addition, the actuator is provided to be closer to the base end portion, and thus it becomes possible to position the gravity center position of the link to be closer to the base end portion in the longitudinal direction of the link body. This enables provision of the coupling part to be closer to the base end portion, such that the movable range of the arm unit in accordance with the rotation of the link can be ensured to be larger than that in a case where the coupling part is provided to be closer to the tip end. Therefore, it becomes possible to improve the versatility of the robot, while suppressing the energy consumption related to the posture control.

According to the above aspect (4), the buoyancy body is provided to be closer to the tip end portion of the link body. Thus, when the robot does work underwater in particular, the buoyancy of the tip end portion of the link can be increased, and the weight balance of the link as a whole can be easily adjusted. Further, the tip end portion of the link becomes light, and thus it becomes possible to position the gravity center position of the link to be relatively closer to the base end portion in the longitudinal direction of the link body. This enables provision of the coupling part to be closer to the base end portion, so that a large movable range of the arm unit in accordance with the rotation of the link can be ensured. Therefore, the versatility of the robot can be improved. In addition, it becomes possible to have a suitable constitution of the robot, which does work underwater in particular.

According to the above aspect (5), the counterweight is provided to be closer to the base end portion of the link body. Thus, the weight of the base end portion in the link can be easily increased, and the weight balance of the link as a whole can be easily adjusted. In addition, the gravity center position of the link can be positioned to be closer to the base end portion in the longitudinal direction of the link body, so that a large movable range of the arm unit in accordance with the rotation of the link can be ensured. Therefore, the versatility of the robot can be improved.

According to the above aspect (6), it becomes possible to transmit the output from the actuator to the coupling part via the plurality of gears. Therefore, the actuator can be disposed at any position. Therefore, the gravity center position of the link can be easily adjusted, and the versatility of the robot can be improved.

According to the above aspect (7), at least one of the plurality of gears is a bevel gear. This enables a constitution suitable for a case where the output shaft of the actuator intersects the rotation axis of the link. Therefore, the versatility of the robot can be improved.

According to the above aspect (8), the output of the actuator and the rotation axis (the coupling part) are couplable with each other via the belt. Therefore, the versatility of the robot can be improved.

According to the aspect of (9), the controller provided in the robot main body switches between the validity and invalidity of the posture control, based on a determination result of whether the work part (a hand) is grasping an object. For example, in a case where the work part is not grasping an object, the posture control is invalid. This enables suppression of unnecessary energy consumption related to the posture control. In addition, upon detection that the work part is grasping an object, the posture control becomes valid. This enables appropriate posture control to be conducted in accordance with a change of the gravity center of the arm unit. Therefore, it becomes possible to maintain the posture of the robot, while minimizing the energy consumption.

### BRIEF DESCRIPTION OF THE DRAWINGS

FIG. 1 is a perspective view showing a constitution of a robot according to a first embodiment;

FIG. 2 is a front view showing an extended state of an arm unit;

FIG. 3 is a front view showing a bent state of the arm unit;

FIG. 4 is a front view showing a constitution of a transmission mechanism according to the first embodiment;

FIG. 5 is a side view showing the constitution of the transmission mechanism according to the first embodiment;

FIG. 6 is a control flowchart in a controller;

FIG. 7 is a front view showing a constitution of a transmission mechanism according to a second embodiment;

FIG. 8 is a side view showing the constitution of the transmission mechanism according to the second embodiment;

FIG. 9 is a front view showing a constitution of a transmission mechanism according to a third embodiment;

FIG. 10 is a side view showing the constitution of the transmission mechanism according to the third embodiment;

FIG. 11 is a side view showing a constitution of a transmission mechanism according to a modification of the third embodiment;

FIG. 12 is a front view showing a constitution of a transmission mechanism according to a fourth embodiment; and

FIG. 13 is a side view showing the constitution of the transmission mechanism according to the fourth embodiment.

### DETAILED DESCRIPTION OF THE INVENTION

Hereinafter, embodiments of the present invention will be described with reference to the drawings.

In the following description, as an example of a robot 1, a robot (Remotely Operated Vehicle (ROV)) that performs an operation undersea (an example of underwater) in accordance with a remote operation on wired communication or the like will be described.

The robot 1 in an embodiment is, for example, an unmanned undersea vehicle (UUV), an unmanned surface vehicle (USV), or the like, which is an unmanned movable body on and under the water. Examples of the UUV, which is an unmanned submersible, include a remotely operated vehicle (ROV) and an autonomous underwater vehicle (AUV). Examples of the ROV include a so-called underwater drone.

### FIRST EMBODIMENT

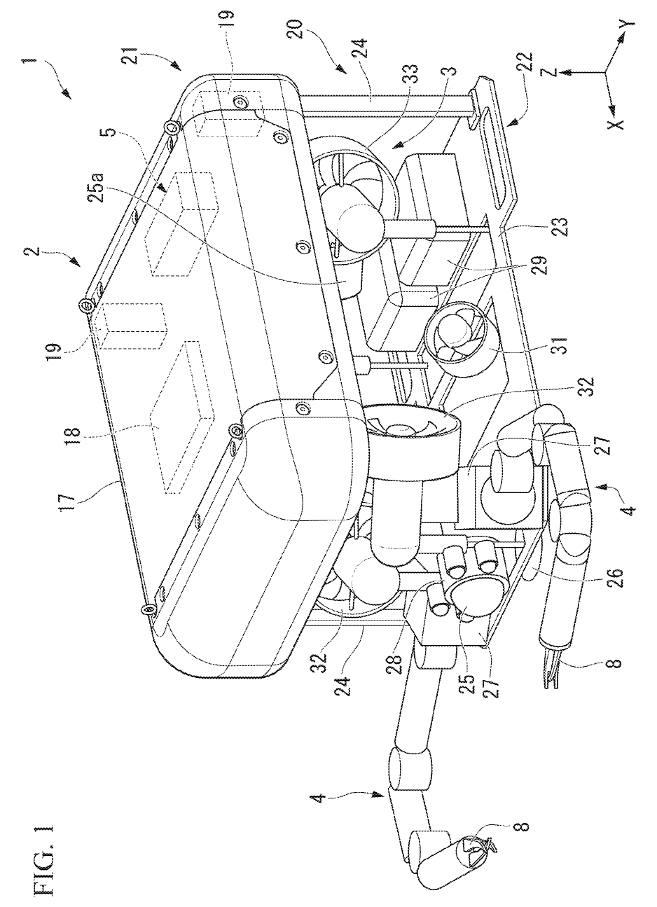

FIG. 1 is a perspective view showing a constitution of the robot 1 according to a first embodiment.

Hereinafter, description will be made with reference to X-axis, Y-axis, and Z-axis, which are orthogonal to one another in a three-dimensional space. For example, as shown in FIG. 1, X-axis direction is parallel to a front-rear direction of the robot 1, Y-axis direction is parallel to a left-right direction of the robot 1, and Z-axis direction is parallel to an up-down direction of the robot 1. For example, a positive direction of X-axis is a forward direction of the robot 1, a positive direction of Y-axis is a leftward direction of the robot 1, and a positive direction of Z-axis is an upward direction of the robot 1.

As shown in FIG. 1, the robot 1 includes a robot main body 2, a plurality of thrusters 3 (propulsors recited in claims), an arm unit 4, and a controller 5.

The robot main body 2 includes a main body lower portion 20 and a main body upper portion 21, which are connected with each other.

The main body lower portion 20 includes a plurality of support column members 24 and a plate member 23, which form a frame 22, and the frame 22 serves as a skeleton of the robot 1. The plurality of support column members 24 each have an outer shape formed in a columnar shape that extends along the up-down direction. The plurality of support column members 24 are respectively fixed to, for example, corner portions of the plate member 23 and are also coupled with the main body upper portion 21 to be described later. The plate member 23 is formed in, for example, a rectangular plate shape along an XY plane. The plate member 23 supports various pieces of equipment mounted on the main body lower portion 20.

The main body lower portion 20 includes, for example, a pair of arm units 4, the plurality of thrusters 3, a camera system 25, a sensor 26, a dynamic power device 27, one front control unit 28, and two rear control units 29, which will be described later in detail.

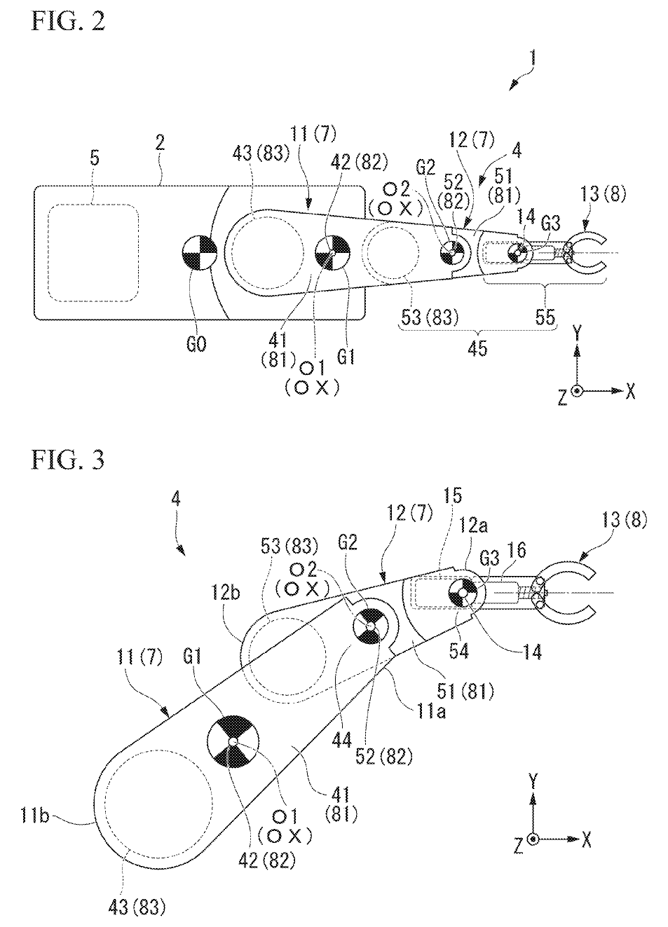

The base end portions of the pair of arm units 4 are respectively fixed to left and right corner portions in a front part of the plate member 23. Each arm unit 4 is, for example, a manipulator, and includes a coupling part (a joint) to be driven by an actuator (see FIG. 2), and a plurality of links 7, which are connected by the coupling part. Each arm unit 4 includes, for example, a work part 8, which is provided at a tip end portion, and which does various types of work such as grasping and moving an object. Each arm unit 4 includes, at its base end portion, the dynamic power device 27, which outputs dynamic power for operation. Each arm unit 4 is disposed, for example, inside left and right end portions of the plate member 23 while stopping and causes the tip end portion to protrude outward (forward or the like) from the robot 1 while in operation.

The plurality of thrusters 3 includes: two front thrusters 32, which are provided in the front part of the plate member 23; two rear thrusters 33, which are provided in a rear part of the plate member 23; and two central thrusters 31, which are provided in a center part in the front-rear direction of the plate member 23. Pairs of thrusters 3 (the front thrusters 32, the rear thrusters 33, and the central thrusters 31) are respectively provided on the left and right to be aligned with each other.

The front thruster 32 and the rear thruster 33 are each a so-called azimuth thruster. The front thrusters 32 and the rear thrusters 33 each include, for example: a support portion, which rotates about a vertical axis along the up-down direction; and a propeller, which is supported by the support portion, and which rotates about a horizontal axis orthogonal to the vertical axis. The front thrusters 32 and the rear thrusters 33 generate thrust in a direction orthogonal to the up-down direction.

Each central thruster 31 includes, for example, a propeller that rotates about a rotation axis inclined at an acute angle with respect to the up-down direction. Each central thruster 31 generates thrust in a direction including at least the up-down direction.

The camera system 25 is disposed in the front part of the plate member 23 and in a center part in the left-right direction of the plate member 23. The camera system 25 includes, for example, a camera that images the outside ahead of the robot 1, a plurality of lamps that illuminate the outside ahead of the robot 1, and the like.

The sensor 26 is disposed, for example, below the camera system 25 in the front part of the plate member 23. The sensor 26 is, for example, a doppler velocity log (DVL), which detects a relative velocity, based on sound wave radiation and detection of reflected waves and scattered waves.

One front control unit 28 is disposed, for example, in a part further on the rear than the camera system 25, in the front part of the plate member 23.

The two rear control units 29 each include, for example, a box-shaped housing, which seals the inside in a sealed state, and a power supply, an electronic control unit, and the like (not shown) disposed inside the housing. Each rear control unit 29 controls the operation of each arm unit 4, each thruster 3, the camera system 25, the sensor 26, and a driver 19, which is provided in the main body upper portion 21 to be described later.

The main body upper portion 21 includes a cover member 17, a movement member 18, and the driver 19.

The cover member 17 has an outer shape in, for example, a rectangular box shape and has a surface on which a plurality of through holes for allowing the inside and the outside to communicate with each other are formed. The cover member 17 is connected with the frame 22 of the main body lower portion 20 via a skeleton member, not shown, provided inside the cover member 17. Such a skeleton member, not shown, is fixed to the support column member 24 of the main body lower portion 20, and also supports the cover member 17, the movement member 18, and the driver 19.

The movement member 18 is provided inside the cover member 17 so as to be movable in X-axis direction and Y-axis direction with respect to the skeleton member, not shown. The movement member 18 includes, for example, a buoyancy member (not shown) that generates buoyancy. The movement member 18 is moved by the driver 19 inside the cover member 17 in order to change at least any of the buoyancy center and the gravity center in the entirety of the robot 1. The movement member 18 is moved to maintain or change the posture of the robot 1, for example, while the robot 1 is moving, each arm unit 4 is operating, or the like.

A pair of drivers 19 are provided, for example, in left and right corner portions of the cover member 17, and each of them includes a dynamic power source. The dynamic power source is, for example, an electric motor. Each dynamic power source generates dynamic power for moving the movement member 18.

Inside the cover member 17, a movement mechanism, not shown, is connected with each dynamic power source. The movement mechanism denotes, for example, a mechanism that moves the movement member 18 in accordance with two-dimensional translational movement in a two-dimensional orthogonal coordinate system of X-axis and Y-axis. The movement mechanism may be a so-called H-BOT or H type gantry robot, or the like.

FIG. 2 is a front view showing an extended state of the arm unit 4. FIG. 3 is a front view showing a bent state of the arm unit 4. FIG. 2 shows a state in which the arm unit 4 is most extended. FIG. 3 shows a state in which the arm unit 4 is at least partially bent with respect to the state of FIG. 2. Note that the pair of arm units 4 have a bilaterally symmetrical constitution. Thus, in the following description, one arm unit 4 (for example, the left arm unit 4) will be described, and description of the other arm unit 4 will be omitted. In addition, in FIGS. 2 and 3, a gravity center position G0 of the robot main body 2 and gravity center positions G1 and G2 of the respective links 7 in the arm are shown for the sake of description.

The arm unit 4 includes: one or more (two in the present embodiment) links 7; and the work part 8, which is provided at a tip end portion of the link 7.

In the present embodiment to be described below, a constitution in which the arm unit 4 includes two links 7 (a first link 11 and a second link 12) and the work part 8 will be described as an example. Each link 11, 12 includes: a link body (a first link body 41, a second link body 51); a coupling part (a first coupling part 42, a second coupling part 52), which is provided coaxially with a rotation axis (a first rotation axis O1, a second rotation axis O2) of the link body; an actuator (a first actuator 43, a second actuator 53), which rotates the link body about the coupling part (about the rotation axis); an attachment portion (a first attachment portion 44, a second attachment portion 54), which attaches an attached component (a first attached component 45, a second attached component 55) to the link body; and a transmission mechanism (a first transmission mechanism 46, a second transmission mechanism (not shown)). Note that in a case where the first link body 41 and the second link body 51 are not distinguished from each other, they will be collectively referred to as a link body 81, in some cases. Similarly, in a case where the first coupling part 42 and the second coupling part 52 are not distinguished from each other, they will be collectively referred to as a coupling part 82, in some cases. In a case where the first actuator 43 and the second actuator 53 are not distinguished from each other, they will be collectively referred to as an actuator 83, in some cases. In a case where the first rotation axis O1 and the second rotation axis O2 are not distinguished from each other, they will be collectively referred to as a rotation axis OX, in some cases.

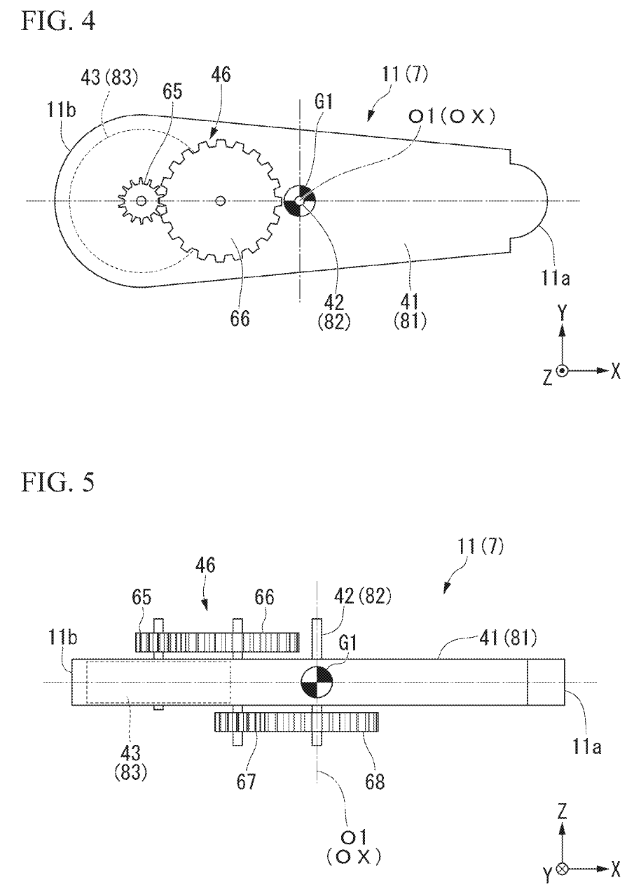

As shown in FIGS. 2 and 3, the first link 11 is attached to the robot main body 2 so as to be rotatable about the first rotation axis O1 along Z-axis direction. The first link 11 includes the first link body 41, the first coupling part 42, a first actuator 43, the first attachment portion 44, and the first transmission mechanism 46 (see FIG. 4).

The first link body 41 is formed in a plate shape with one direction that intersects Z-axis as a long axis direction, and the plate shape extends along the XY plane. In the present embodiment, the first link body 41 has an outer shape formed in such a manner that the dimension in the width direction orthogonal to the longitudinal direction gradually decreases from one end to the other end in the longitudinal direction. In the following description, one end portion (larger in width dimension) in the longitudinal direction of the first link body 41 will be referred to as a base end portion 11b, and the other end portion at the opposite end (smaller in width dimension) will be referred to as a tip end portion 11a, in some cases.

The first coupling part 42 is provided in a substantially center part in the longitudinal direction of the first link body 41. The first coupling part 42 couples the robot main body 2 with the first link body 41 to be rotatable about the first rotation axis O1. In other words, the center axis of the first coupling part 42 and the first rotation axis O1 coincide with each other. The position where the first coupling part 42 is provided will be described later in detail.

The first actuator 43 is provided to be closer to the base end portion 11b of the first link body 41 than to the first coupling part 42. The first actuator 43 is built in the first link body 41. The first actuator 43 includes, for example, a motor in its inside, and outputs the rotational force of the motor to rotate the first link 11 about the first rotation axis O1 with respect to the robot main body 2.

The first attachment portion 44 is provided to be closer to the tip end portion 11a of the first link body 41 than to the first coupling part 42. The first attached component 45 is attached to the first attachment portion 44. The first attached component 45 is a generic term for a component part provided downstream the first link 11, in a case where the robot main body 2 is set to be positioned upstream in a state in which the work part 8 is not grasping an object. In the present embodiment, the first attached component 45 includes the second link 12 and the work part 8.

FIG. 4 is a front view showing a constitution of the transmission mechanism (the first transmission mechanism 46) according to the first embodiment. FIG. 5 is a side view showing the constitution of the transmission mechanism (the first transmission mechanism 46) according to the first embodiment. In FIGS. 4 and 5, illustration of some components other than the first transmission mechanism 46 is omitted. In addition, alternate long and short dash lines in the drawing respectively indicate reference lines that extend in X-axis, Y-axis, and Z-axis with the gravity center position G1 of the first link 11 as the center.

As shown in FIGS. 4 and 5, the first transmission mechanism 46 includes first to fourth gears 65, 66, 67, and 68. The first gear 65 is connected with the output shaft of the first actuator 43 and rotates integrally with the output shaft of the first actuator 43. As shown in FIG. 5, the output shaft of the first actuator 43 protrudes in, for example, +Z-axis direction with respect to the first link body 41. The second gear 66 is provided at a position equivalent to the first gear 65 in Z-axis direction and meshes with the first gear 65. The third gear 67 is connected with the second gear 66 via a gear shaft that extends along Z-axis direction and rotates integrally with the second gear 66. The third gear 67 is provided in -Z-axis direction with respect to the first link body 41. Furthermore, the fourth gear 68 is provided to be integrally rotatable in a part that protrudes in -Z-axis direction with respect to the first link body 41 in the first coupling part 42. The fourth gear 68 meshes with the third gear 67.

In this manner, the rotational force of the first actuator 43 is transmitted to the first coupling part 42 by the plurality of gears of the first transmission mechanism 46, and then the first link 11 rotates about the first rotation axis O1.

In addition, the first gear 65 and the second gear 66 are provided in +Z-axis direction with respect to the first link body 41, and the third gear 67 and the fourth gear 68 are provided in -Z-axis direction with respect to the first link body 41. In this manner, the plurality of gears in the first transmission mechanism 46 are disposed to be distributed on both sides in Z-axis direction, and thus the gravity center position G1 of the first link 11 can be provided in the center part in the plate thickness direction of the first link body 41.

As shown in FIGS. 2 and 3, the second link 12 is attached to the first attachment portion 44 of the first link 11 so as to be rotatable about the second rotation axis O2 along Z-axis direction. The second link 12 includes the second link body 51, the second coupling part 52, the second actuator 53, the second attachment portion 54, and the second transmission mechanism, not shown.

The second link body 51 is formed in a plate shape with one direction that intersects Z-axis as a long axis direction, and the plate shape extends along the XY plane. In the present embodiment, similarly to the first link body 41, the second link body 51 has an outer shape formed in such a manner that the dimension in the width direction orthogonal to the longitudinal direction gradually decreases from one end to the other end in the longitudinal direction. In the following description, one end portion (larger in width dimension) in the longitudinal direction of the second link body 51 will be referred to as a base end portion 12b, and the other end portion at the opposite end (smaller in width dimension) will be referred to as a tip end portion 12a, in some cases.

The second coupling part 52 is provided at a substantially center part in the longitudinal direction of the second link body 51. The second coupling part 52 couples the first attachment portion 44 of the first link body 41 with the second link body 51 to be rotatable about the second rotation axis O2. In other words, the center axis of the second coupling part 52 and the second rotation axis O2 coincide with each other. The position where the second coupling part 52 is provided will be described later in detail.

The second actuator 53 is provided to be closer to the base end portion 12b of the second link body 51 than to the second coupling part 52. The second actuator 53 is built in the second link body 51. The second actuator 53 includes, for example, a motor in its inside and outputs the rotational force of the motor to rotate the second link 12 about the second rotation axis O2 with respect to the first link 11.

The second attachment portion 54 is provided to be closer to the tip end portion 12a of the second link body 51 than to the second coupling part 52. The second attached component 55 is attached to the second attachment portion 54. The second attached component 55 is a generic term for a component part provided further downstream the second link 12 in a state in which the work part 8 is not grasping an object. In the present embodiment, the second attached component 55 includes the work part 8.

The second transmission mechanism (not shown) includes a plurality of gears and transmits the output (the rotational force) of the second actuator 53 to the second coupling part 52. In the present embodiment, the constitution of the second transmission mechanism is equivalent to the constitution of the above-described first transmission mechanism 46, and thus its description will be omitted.

As shown in FIG. 3, the work part 8 is provided on the second attachment portion 54 (the tip end portion 12a of the second link body 51) via a work part coupling part 14. The work part 8 is attached to the second link body 51 so as to be rotatable about a rotation axis along Z-axis direction. In the present embodiment, the work part 8 is a hand including a plurality of fingers 13. Therefore, the work part 8 is capable of grasping an object. A motor 16 for driving the fingers 13 is built in the work part 8. The work part 8 also includes a work part actuator 15 for rotating the work part coupling part 14 with respect to the second link 12. Note that the work part actuator 15 and the motor 16 for driving the fingers 13 may be separate bodies or may be integrated together. In the case where they are integrated together, a switching mechanism or the like for switching an output destination may be separately provided.

Next, the disposed position of each coupling part (the first coupling part 42, the second coupling part 52, and the work part coupling part 14) in each of the above-described links 7 will be described in detail.

First, with regard to the first link 11, in determining the disposed position of the first coupling part 42, the gravity center position G1 in the entire first link 11 is calculated. The gravity center position G1 of the first link 11 is calculated, based on the weight of the first link 11 including the weight of the first link body 41, the weight of the first actuator 43, the weight of the first attached component 45, and the weight of the first transmission mechanism 46. Then, the first coupling part 42 is provided at a position equivalent to the gravity center position G1 of the first link 11. Similarly, with regard to the second link 12, in determining the disposed position of the second coupling part 52, first, the gravity center position G2 in the entire second link 12 is calculated. The gravity center position G2 of the second link 12 is calculated, based on the weight of the second link 12 including the weight of the second link body 51, the weight of the second actuator 53, the weight of the second attached component 55 (that is, the work part 8), and the weight of the second transmission mechanism. Then, the second coupling part 52 is provided at a position equivalent to the gravity center position G2 of the second link 12.

Similarly, with regard to the work part 8, the work part coupling part 14 is provided at a position equivalent to a gravity center position G3 of the work part 8.

Note that “a position equivalent to a gravity center position” recited in the claims is not limited to a case where the gravity center position G1 or G2 of each link 7 completely coincides with the position of the corresponding coupling part 82 (or the corresponding rotation axis OX), and includes a case where the coupling part 82 is provided in the vicinity of the gravity center position G1 or G2. As an example of the “vicinity”, for example, the first coupling part 42 may be provided at least between the gravity center (or the output shaft) of the first actuator 43 and the gravity center position G1 of the first link 11.

As shown in FIG. 1, the controller 5 is provided in the robot main body 2. The controller 5 controls the actuator 83, which drives the arm unit 4, and the above-described thrusters 3. The controller 5 includes a posture controller. The posture controller conducts posture control, by moving the buoyancy member included in the above-described movement member 18 along X-axis direction or Y-axis direction (or both directions) to change at least one of the gravity center or the buoyancy center of the robot 1.

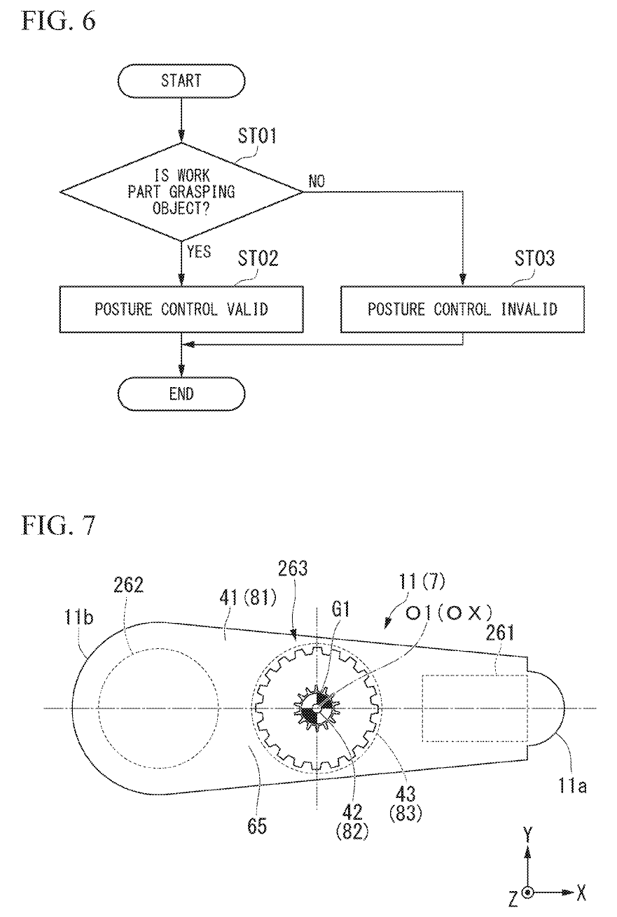

FIG. 6 is a control flowchart by the controller 5.

As shown in FIG. 6, in addition to the above-described posture control of the robot 1, the controller 5 determines whether the work part 8 is grasping an object, and conducts switching control for switching between validity and invalidity of the posture control, based on a determination result.

In the switching control, first, it is determined whether the work part 8 is grasping an object (step ST01). Note that the determination in step ST01 is repeatedly made, for example, at a predetermined cycle set beforehand. The determination whether the work part 8 is grasping an object in step ST01 is made, for example, based on an output result of a pressure sensitive sensor provided on the finger 13 of the work part 8. For example, when the output value of the pressure sensitive sensor exceeds a predetermined threshold, the controller 5 determines that the work part 8 is grasping an object. As another example, the controller 5 may acquire a load of the motor 16 for moving the fingers 13 to determine whether the work part 8 is grasping an object, based on a n acquired value of the load.

In a case where it is determined in step ST01 that the work part 8 is not grasping an object (NO in ST01), the processing proceeds to step ST03. In step ST03, the above-described posture control is switched to be invalid, and the processing of the flowchart ends. That is, the posture controller stands by without conducting the posture control.

On the other hand, in a case where it is determined in step ST01 that the work part 8 is grasping an object (YES in ST01), the processing proceeds to step ST02. In step ST02, the above-described posture control is switched to be valid, and the processing of the flowchart ends.

The posture control is switched to be valid, and then the posture controller conducts the posture control. When the posture control is valid, the posture controller detects the current posture of the robot 1, and moves the movement member 18 so that the detected current posture coincides with a preset (or calculated) target posture. Thus, the posture controller conducts the control to maintain the posture of the robot 1 constant.

According to the robot 1 in the present embodiment, the arm unit 4 includes the link body 81, the coupling part 82, and the actuator 83. The link body 81 rotates about the coupling part 82, and then it becomes possible to extend or bend the arm unit 4 (or the work part 8, which is provided at the tip end portion of the arm unit 4) with respect to the robot main body 2. In addition, the coupling part 82 is provided at a position equivalent to the gravity center position G1 or G2 of the link 7 in the longitudinal direction of the link 7. Thus, even when the arm unit 4 is extended or bent in accordance with the rotation of the link body 81, a change amount of the gravity center position in the entire arm unit 4 can be made small. In particular, in a case where the positions of the coupling parts 82 respectively coincide with the gravity center positions G1 and G2 of the links 7, the gravity center position in the entire arm unit 4 is unchanged regardless of extension or bending of the arm unit 4. Therefore, the energy consumption related to the posture control can be suppressed to be smaller than that in the prior art in which the posture control is conducted every time whenever the arm unit 4 is extended or bent.

In addition, even in a case where the disposed positions of the coupling parts 82 are respectively provided in the vicinity of the gravity center positions G1 and G2 of the links 7 (that is, a case where the positions of the coupling parts 82 do not completely coincide respectively with the gravity center positions G1 and G2 of the links 7), the energy consumption can be suppressed to be smaller than that in the prior art. Here, in general, in a case where the arm unit 4 is constituted using the link mechanism, in order to maximize the movable range of the arm unit 4, the coupling part 82 (the rotation axis OX of the link 7) is provided near the base end portion of the link 7, in many cases. That is, in the prior art in which no consideration is given to the gravity center position, the coupling part 82 is provided at a position away from the gravity center position G1 or G2 of the link 7, in many cases. On the other hand, according to an aspect of the present invention, by providing the coupling parts 82 respectively in the vicinity of the gravity center positions G1 and G2 of the links 7, it becomes possible to make a change in posture in accordance with extension or bending of the arm unit 4 smaller than that in the prior art in which the coupling parts 82 are respectively provided at positions away from the gravity center positions G1 and G2 of the links 7. Therefore, the energy consumption amount related to the posture control can be made smaller.

Therefore, it becomes possible to provide the robot 1, which is capable of suppressing the energy consumption to be smaller than that in the prior art.

Since the arm unit 4 includes two links 7, which are the first link 11 and the second link 12, each link 7 is made to rotate about its rotation axis OX, so that a large movable range in accordance with extension or bending of the arm unit 4 can be ensured. In addition, since the coupling parts 82 of the respective links 7 are provided at positions equivalent to the gravity center positions G1 and G2 in the respective links 7, even in a case where a plurality of links 7 are used, a change amount of the gravity center position in the entire arm unit 4 in accordance with extension or bending of the arm unit 4 can be suppressed to be small. Therefore, it becomes possible to improve the convenience of the robot 1, while suppressing the energy consumption.

The actuators 83 are respectively provided to be closer to the base end portions 11b and 12b than to the coupling parts 82 in the longitudinal direction of the links 7. Since the actuators 83, each of which is a heavy object, are respectively provided to be closer to the base end portions 11b and 12b of the link body 81, it becomes easy to balance the weight with the attached components 45 and 55, which are respectively provided to be closer to the tip end portions 11a and 12a of the links 7. In addition, the actuators 83 are respectively provided to be closer to the base end portions 11b and 12b, and thus it becomes possible to respectively position the gravity center positions G1 and G2 of the links 7 to be closer to the base end portions 11b and 12b in the longitudinal direction of the link bodies 41 and 51. This enables provision of the coupling parts 82 to be closer to the base end portions 11b and 12b, so that the movable range of the arm unit 4 in accordance with the rotation of the link 7 can be ensured to be larger than that in a case where the coupling part 82 is provided to be closer to the tip end. Therefore, it becomes possible to improve the versatility of the robot 1, while suppressing the energy consumption related to the posture control.

The robot 1 further includes the transmission mechanism 46 including: the first gear 65, which is connected with the output shaft of the actuator 83; and the second gear 66, which transmits the rotational force from the first gear 65 to the coupling part 82. Thus, it becomes possible to transmit the output from the actuator 83 to the coupling part 82 via the plurality of gears. Therefore, the actuator 83 can be disposed at any position. Therefore, the gravity center positions G1 and G2 of the links 7 can be easily adjusted, and the versatility of the robot 1 can be improved.

The controller 5, which is provided in the robot main body 2, switches between the validity and invalidity of the posture control, based on a determination result of whether the work part 8 (a hand) is grasping an object. For example, in a case where the work part 8 is not grasping an object, the posture control is invalid. This enables suppression of unnecessary energy consumption related to the posture control. In addition, upon detection that the work part 8 is grasping an object, the posture control becomes valid. This enables appropriate posture control to be conducted in accordance with a change of the gravity center of the arm unit 4. Therefore, it becomes possible to maintain the posture of the robot 1, while minimizing the energy consumption.

Next, second to fourth embodiments according to the present invention will be described with reference to FIGS. 7 to 13. The second to fourth embodiments are different from the above-described first embodiment mainly in the constitution of the transmission mechanism. Note that in the following description, the constitution of the first transmission mechanism 46, which is provided in the first link 11, will be described as an example of the repertoire of the transmission mechanism, and the description of the second transmission mechanism provided in the second link 12 will be omitted. The second transmission mechanism may have a constitution equivalent to that of the first transmission mechanism 46 or may have a constitution different from that of the first transmission mechanism 46.

### SECOND EMBODIMENT

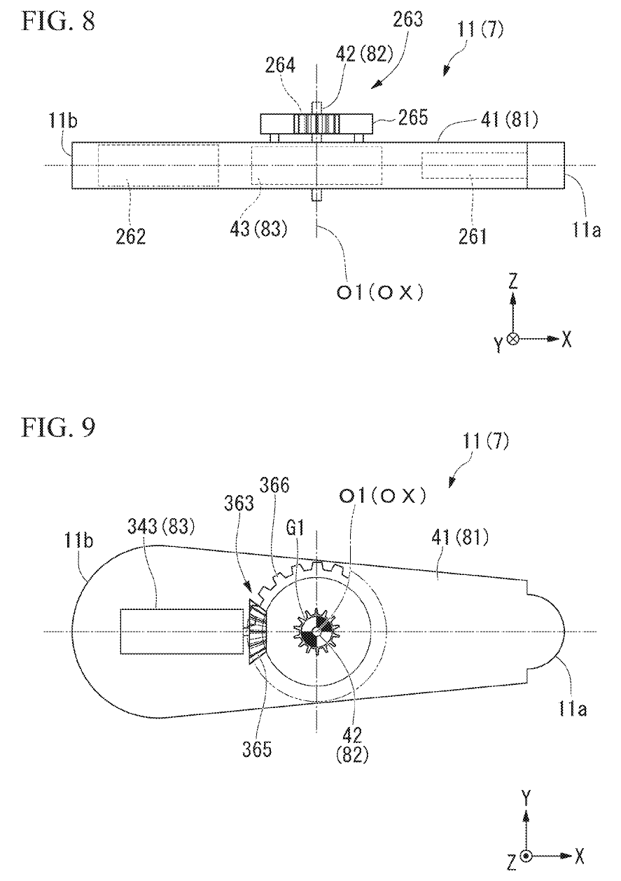

First, a second embodiment according to the present invention will be described. FIG. 7 is a front view showing a constitution of a transmission mechanism 263 according to the second embodiment. FIG. 8 is a side view showing the constitution of the transmission mechanism 263 according to the second embodiment.

As shown in FIGS. 7 and 8, in the second embodiment, the first actuator 43 is provided coaxially with the first rotation axis O1 (the first coupling part 42). A transmission mechanism 263 is, for example, a planetary gear including: a sun gear 264, which is connected with the output shaft of the first actuator 43; and an outer gear 265, which is connected with the first link body 41.

Furthermore, in the present embodiment, a buoyancy body 261 is provided to be closer to the tip end portion 11a than to the first actuator 43 in the longitudinal direction of the first link body 41. A counterweight 262 is also provided to be closer to the base end portion 11b than to the first actuator 43 in the longitudinal direction of the first link body 41.

According to the robot 1 in the second embodiment, it is possible to coaxially provide the first actuator 43 and the first coupling part 42. Therefore, the versatility of the transmission mechanism 263 can be improved.

In addition, the buoyancy body 261 is provided to be closer to the tip end portion 11a of the link body 41. Thus, when the robot 1 does work underwater in particular, the buoyancy of the tip end portion 11a of the first link 11 can be increased, and the weight balance of the first link 11 as a whole can be easily adjusted. Further, the tip end portion 11a of the first link 11 becomes light, and thus it becomes possible to position the gravity center position G1 of the first link 11 to be relatively closer to the base end portion 11b in the longitudinal direction of the link body 41. This enables provision of the coupling part 42 to be closer to the base end portion 11b, so that a large movable range of the arm unit 4 in accordance with the rotation of the first link 11 can be ensured. Therefore, the versatility of the robot 1 can be improved. In addition, it becomes possible to have a suitable constitution of the robot 1, which does work underwater in particular.

The counterweight 262 is provided to be closer to the base end portion 11b of the link body 41. Thus, the weight of the base end portion 11b in the first link 11 can be easily increased, and the weight balance of the first link 11 as a whole can be easily adjusted. In addition, the gravity center position G1 of the first link 11 can be positioned to be closer to the base end portion 11b in the longitudinal direction of the link body 41, so that a large movable range of the arm unit 4 in accordance with the rotation of the first link 11 can be ensured. Therefore, the versatility of the robot 1 can be improved.

### THIRD EMBODIMENT

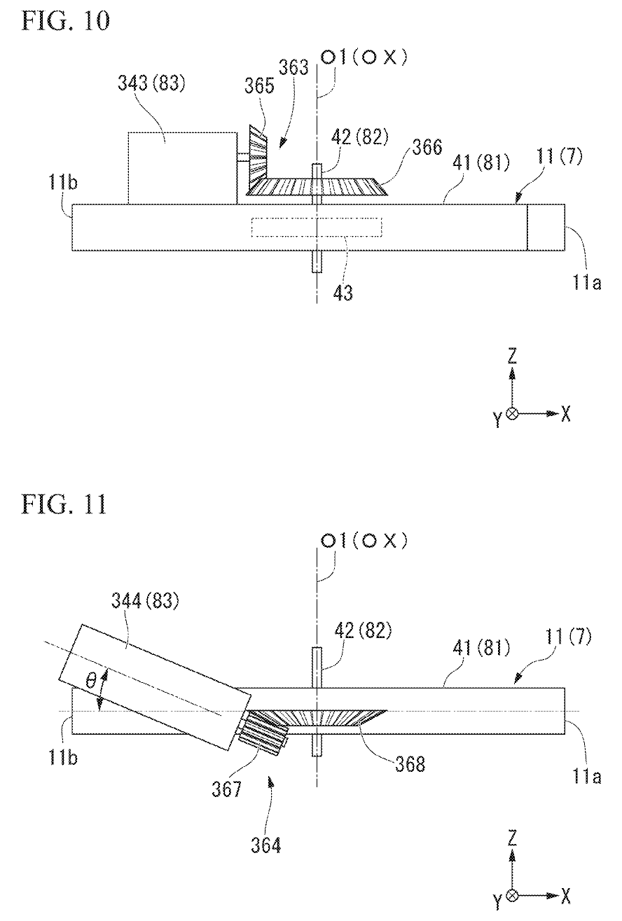

Next, a third embodiment according to the present invention will be described. FIG. 9 is a front view showing a constitution of a transmission mechanism 363 according to a third embodiment. FIG. 10 is a side view showing the constitution of the transmission mechanism 363 according to the third embodiment.

As shown in FIGS. 9 and 10, in the third embodiment, a first actuator 343 includes an output shaft that extends in X-axis direction. The first transmission mechanism 363 includes a first bevel gear 365 and a second bevel gear 366. The first bevel gear 365 is connected with an output shaft of the first actuator 343 and rotates about a rotation axis along X-axis. The second bevel gear 366 is connected with the first coupling part 42 and rotates about the rotation axis (the first rotation axis O1) along Z-axis direction.

FIG. 11 is a side view showing a constitution of a transmission mechanism 364 according to a modification of the third embodiment. As shown in FIG. 11, in the modification of the third embodiment, a first actuator 344 is disposed and inclined to form a predetermined inclination angle θ with respect to X-axis when viewed in Y-axis direction. The first transmission mechanism 364 includes a first gear 367, and a second bevel gear 368. The first gear 367 is connected with an output shaft of the first actuator 344. The second bevel gear 368 is connected with the first coupling part 42. The second bevel gear 368 denotes a bevel gear having a tapered surface corresponding to the inclination angle θ.

According to the robot 1 in the third embodiment and the modification, at least one of the plurality of gears is a bevel gear. This enables a constitution suitable for a case where the output shaft of the actuator 343, 344 intersects the first rotation axis O1 of the first link 11. Therefore, the versatility of the robot 1 can be improved.

### FOURTH EMBODIMENT

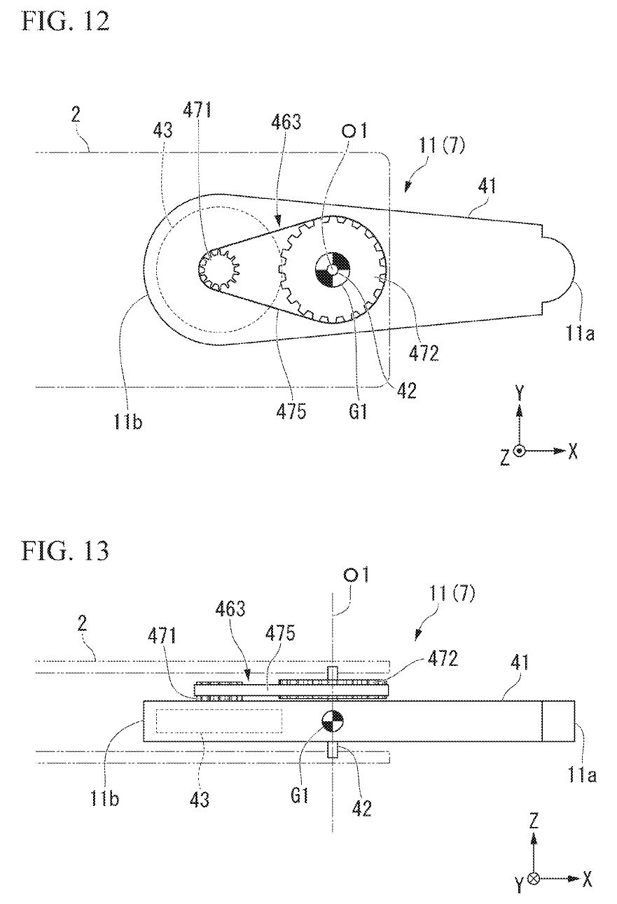

Next, a fourth embodiment according to the present invention will be described. FIG. 12 is a front view showing a constitution of a transmission mechanism 463 according to a fourth embodiment. FIG. 13 is a side view showing the constitution of the transmission mechanism 463 according to the fourth embodiment.

As shown in FIGS. 12 and 13, in the fourth embodiment, the first actuator 43 is provided to be closer to the base end portion 11b than to the first coupling part 42. The first transmission mechanism 463 includes a driving pulley 471, a driven pulley 472, and a belt 475. The driving pulley 471 is connected with an output shaft of the first actuator 43 and rotates integrally with the output shaft. The driven pulley 472 is connected with the first coupling part 42. The belt 475 is bridged between the driving pulley 471 and the driven pulley 472 and transmits the output from the driving pulley 471 to the driven pulley 472.

According to the robot 1 in the fourth embodiment, the output shaft of the first actuator 43 and the first rotation axis O1 (the first coupling part 42) are couplable with each other via the belt 475. Therefore, the versatility of the robot 1 can be improved.

Note that the technical scope of the present invention is not limited to the above-described embodiments, and various modifications can be made without departing from the gist of the present invention.

For example, in the above-described first embodiment, the processing of the flowchart of the switching control shown in FIG. 6 is constituted to be repeatedly conducted at a predetermined cycle, but the present invention is not limited to this. For example, the controller 5 may periodically acquire an output value from the pressure sensitive sensor of the finger 13 and perform the processing of the flowchart of FIG. 6, when the output value exceeds a predetermined threshold.

There is no intention of limiting the number of the links 7, which are included in the arm unit 4, to two.

In the first embodiment, there is no intention of limiting the number of gears included in the first transmission mechanism 46 to four. As an example, it is sufficient that the first transmission mechanism 46 includes only two gears including the first gear connected with the output shaft of the first actuator 43 and the second gear connected with the first coupling shaft and meshing with the first gear (none of the gears is shown). In addition, the constitutions of the above-described embodiments may be combined together as the constitution of the transmission mechanism.

The gravity center positions G1 and G2 may be adjusted in any method other than the method of providing the counterweight 262 and the buoyancy body 261. As an example, the gravity center positions G1 and G2 may be adjusted by changing the plate thickness or the shape of the link body 81.

In each of the above-described embodiments, the robot 1, which does work underwater, has been described as an example of the robot 1, but there is no intention of limiting the work environment to this. The present invention may be applied to the robot 1, which does work in any environment other than underwater (for example, on land). In this case, instead of providing the buoyancy body 261, a weight-reduced portion, a low-density lightweight member, or the like may be provided.

The shape of the work part 8 is not limited to the shown one. In addition, as another example of the work part 8, for example, one that cleans by generating a water flow (or wind) with a propeller, a camera for taking an underwater photo, a known flaw detection sensor for carrying out nondestructive inspection of a defect such as a crack and corrosion present near the surface of a conductor such as metal, or the like may be applied.

In addition, it is possible to appropriately replace the constituent elements in the above-described embodiments with well-known constituent elements without departing from the gist of the present invention, and the above-described embodiments may be appropriately combined together.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

### REFERENCE SIGNS LIST

1 Robot
2 Robot main body
3 Thruster (propulsor)
4 Arm unit
5 Controller
7 Link
8 Work part
11 First link (link)
12 Second link (link)
11a, 12a Tip end portion
11b, 12b Base end portion
13 Finger
41 First link body (link body)
42 First coupling part (coupling part)
43, 343, 344 First actuator (actuator)
45 First attached component (attached component)
46 First transmission mechanism (transmission mechanism)
51 Second link body (link body)
52 Second coupling part (coupling part)
53 Second actuator (actuator)
55 Second attached component (attached component)
65 First gear
66 Second gear
81 Link body
82 Coupling part
83 Actuator
261 Buoyancy body
262 Counterweight
263, 363, 364, 463 Transmission mechanism
471 Driving pulley
472 Driven pulley
475 Belt G1, G2 Gravity center position
O1 First rotation axis (rotation axis)
O2 Second rotation axis (rotation axis)
OX Rotation axis

What is claimed is:

1. A robot comprising:
a robot main body;
a propulsor configured to drive the robot main body;
an arm unit coupled with the robot main body and including at least one link and a work part provided at a tip end portion of the at least one link; and
a controller configured to control an actuator and the propulsor, the actuator being configured to drive the arm unit, wherein
the at least one link includes:
a link body;
a coupling part that couples the link body with the robot main body for the link body to be rotatable about a rotation axis; and
the actuator that is attached to the link body, and that rotates the link body about the rotation axis, and
wherein the coupling part is provided at a position equivalent to a gravity center position of the at least one link in a longitudinal direction of the at least one link, the at least one link including the link body, the actuator and an attached component attached to a tip end portion of the link body.

2. The robot according to claim 1, wherein
the at least one link includes a first link and a second link,
the first link includes:
a first link body;
a first coupling part that couples the robot main body with the first link body to be rotatable about a first rotation axis; and
a first actuator that rotates the first link about the first rotation axis,
the second link includes:
a second link body connected with a tip end portion of the first link body;
a second coupling part that couples the tip end portion of the first link body with the second link body to be rotatable about a second rotation axis; and
a second actuator that rotates the second link about the second rotation axis,
the work part is provided at a tip end portion of the second link body,
the first coupling part is provided at a position equivalent to a gravity center position of the first link in a longitudinal direction of the first link, the first link including the first link body, the first actuator and a first attached component attached to the tip end portion of the first link body, and
the second coupling part is provided at a position equivalent to a gravity center position of the second link in a longitudinal direction of the second link, the second link including the second link body, the second actuator and the work part attached to the tip end portion of the second link body.

3. The robot according to claim 1, wherein
the actuator is provided to be closer to a base end portion than to the coupling part in the longitudinal direction of the at least one link, the base end portion being positioned at an opposite end to the tip end portion to which the attached component is attached.

4. The robot according to claim 1, wherein
the at least one link further includes a buoyancy body provided to be closer to the tip end portion of the at least one link than to the coupling part in the longitudinal direction of the at least one link, and
the robot does work underwater.

5. The robot according to claim 1, wherein
the at least one link further includes a counterweight provided to be closer to a base end portion than to the coupling part in the longitudinal direction of the at least one link, the base end portion being positioned at an opposite end to the tip end portion to which the attached component is attached.

6. The robot according to claim 1, further comprising
a transmission mechanism including a first gear connected with an output shaft of the actuator and a second gear connected with the first gear to transmit rotational force from the first gear to the coupling part.

7. The robot according to claim 6, wherein
at least one of the first gear or the second gear is a bevel gear.

8. The robot according to claim 1, further comprising
a transmission mechanism including a driving pulley connected with an output shaft of the actuator, a driven pulley connected with the coupling part and a belt that transmits output from the driving pulley to the driven pulley.

9. The robot according to claim 1, wherein
the controller includes a posture controller configured to conduct posture control to change at least one of a gravity center or a buoyancy center of the robot by moving a buoyancy member,
the work part serves as a hand including a plurality of fingers, and
the controller determines whether the hand is grasping an object, and switches between validity and invalidity of the posture control based on a determination result.
